(19) United States
(12) Patent Application Publication
(10) Pub. No.: US 2020/0211533 A1
(43) Pub. Date: Jul. 2, 2020

(54) PROCESSING METHOD, DEVICE AND ELECTRONIC APPARATUS

(71) Applicant: Lenovo (Beijing) Co., Ltd., Beijing (CN)

(72) Inventor: Fei LU, Beijing (CN)

(21) Appl. No.: 16/730,161

(22) Filed: Dec. 30, 2019

(30) Foreign Application Priority Data
Dec. 30, 2018 (CN) 201811644602.5

(51) Int. Cl. G10L 15/08; G06F 40/20

(52) U.S. Cl. CPC G10L 15/08; G10L 2015/088; G06F 40/20

(57) ABSTRACT

The present application disclosed a processing method, device, and an electronic apparatus configured to obtain media data, output first media data to a first recognition module, and obtaining a first recognition result of the first media data, where the first media data is a part of the media data, to output second media data to a second recognition module, and obtain a second recognition result of the second media data, where the second media data is a part of the media data, and to obtain a recognition result of the media data at least based on the first recognition result and the second recognition result. In the solution, the media data are recognized by the first recognition module and the second recognition module to realize the recognition of multi-languages and improve user experience.

### TECHNICAL FIELD

The present disclosure relates to the technical field of control and, more particularly, to a processing method, a processing device, and an electronic apparatus.

### BACKGROUND

Currently, to implement the automatic recognition of a speech including at least two types of languages, the speech is often sent to a hybrid speech recognizer for the hybrid speech recognizer to recognize the speech. This results in issues such as a high processing volume of the system data and a reduced processing efficiency.

### SUMMARY

In accordance with the present application, there is provided a processing method, device, and electronic apparatus, the specific solutions of which are as follows.

The processing method includes obtaining media data, outputting a first media data to a first recognition module and obtaining a first recognition result of the first media data, where the first media data are at least a part of the media data. The processing method further includes outputting a second media data to a second recognition module and obtaining a second recognition result of the second media data, where the second media data are at least a part of the media data. The processing method further includes obtaining a final recognition result of the media data based on the first recognition result and the second recognition result.

In addition, outputting the second media data to the second recognition module includes determining whether the first recognition result satisfies a preset condition, in response to the first recognition result satisfying the preset condition, determining the second media data, and outputting the second media data to the second recognition module.

In addition, the preset condition includes identifying a keyword in the first recognition result or identifying data in the first recognition result that is unrecognized by the first recognition module.

In addition, if the preset condition is identifying the keyword in the first recognition result, outputting the second media data to the second recognition module includes determining the keyword in the first recognition result from a plurality of candidate keywords, determining a second recognition module to which the keyword corresponds from a plurality of candidate recognition modules, and outputting the second media data to the second recognition module.

In addition, in response to the preset condition being identifying the keyword in the first recognition result, determining the second media data includes determining data at a preset location with respect to the keyword in the first media data as the second media data, or in response to the preset condition being identifying the data in the first recognition unit that is unrecognized by the first recognition module, determining the second media data includes determining the data unrecognized by the first recognition module as the second media data.

In addition, in response to the preset condition being identifying the keyword in the first recognition result, obtaining the final recognition result at least based on the first recognition result and the second recognition result includes determining a preset location with respect to the keyword in the first recognition result and placing the second recognition result in the preset location with respect to the keyword in the first recognition result, thereby obtaining the final recognition result of the media data, or in response to the preset condition being identifying the data in the first recognition unit that is unrecognized by the first recognition module, obtaining the final recognition result of the media data based on the first recognition result and the second recognition result includes determining a location of data unrecognizable by the first recognition module in the first recognition result and placing the second recognition result in the location of the data unrecognizable by the first recognition module in the first recognition result, thereby obtaining the final recognition result of the media data.

In addition, the media data, the first media data, and the second media data are the same.

In addition, obtaining the final recognition result of the media data at least based on the first recognition result and the second recognition result includes obtaining the first recognition result by using the first recognition module to recognize a first portion of the media data, obtaining the second recognition result by using the second recognition module to recognize a second portion of the media data, and combining the first recognition result and the second recognition result to obtain the final recognition result of the media data, or obtaining the first recognition result by using the first recognition module to recognize the media data, obtaining the second recognition result by using the second recognition module to recognize the media data, matching the first recognition result and the second recognition result to obtain a multi-language matching degree order, and determining the final recognition result of the media data based on the multi-language matching degree order.

The electronic apparatus includes a processor configured to obtain media data, output first media data to a first recognition module, and obtain a first recognition result of the first media data, where the first media data is a part of the media data. The processor is further configured to output second media data to a second recognition module and obtain a second recognition result of the second media data, where the second media data is at least a part of the media data. The processor is further configured to obtain the final recognition result of the media data based on the first recognition result and the second recognition result. The electronic apparatus further includes a memory configured to store the first recognition result, the second recognition result, and the final recognition result.

The processing device includes a first acquiring unit configured to obtain media data. The processing device further includes a first result acquiring unit configured to output the first media data to the first recognition module and obtain the first recognition result of the first media data, where the first media data is at least a part of the media data. The processing device further includes a second result acquiring unit configured to output the second media data to the second recognition module and obtain the second recognition result of the second media data, where the second recognition result is at least a part of the media data. The processing device further includes a second acquiring unit configured to obtain the final recognition result of the media data at least based on the first recognition result and the second recognition result.

It can be seen from the above-mentioned technical solution, the processing method, device, and electronic apparatus disclosed in this application obtain the media data, output the first media data to the first recognition module, and obtain the first recognition result of the first media data. The first media data is at least a part of the media data, the second media data is output to the second recognition module, and a second recognition result of the second media data is obtained. The second media data is at least a part of the media data, the final recognition result of the media data is obtained at least based on the first recognition result and the second recognition result. In this solution, the media data is recognized by the first recognition module and the second recognition module. Recognition of multi-languages is realized, and user experience is improved.

### BRIEF DESCRIPTION OF THE DRAWINGS

To more clearly illustrate embodiments of the present disclosure or technical solutions in existing technologies, drawings accompanying the disclosed embodiments or existing technologies are hereinafter introduced briefly. Obviously, the accompanying drawings in the following descriptions are some embodiments of the present disclosure, and for those ordinarily skilled in the relevant art, other drawings can be obtained based on those accompanying drawings without creative labor.

FIG. 1 illustrates a flow chart of a processing method according to some embodiments of the present disclosure;

FIG. 2 illustrates a flow chart of a processing method according to some embodiments of the present disclosure;

FIG. 3 illustrates a flow chart of a processing method according to some embodiments of the present disclosure;

FIG. 4 illustrates a flow chart of a processing method according to some embodiments of the present disclosure;

FIG. 5 illustrates a structural schematic view of an electronic apparatus according to some embodiments of the present disclosure; and

FIG. 6 illustrates a structural schematic view of a processing device according to some embodiments of the present disclosure.

### DETAILED DESCRIPTION OF THE EMBODIMENTS

The technical solutions of the embodiments in the present application will be described clearly and completely with reference to the accompanying drawings of the present disclosure. Obviously, the embodiments described hereinafter are some but not all embodiments of the present disclosure. Based on embodiments of the present disclosure, all other embodiments obtainable by those ordinarily skilled in the relevant art without creative labor shall fall within the protection scope of the present disclosure.

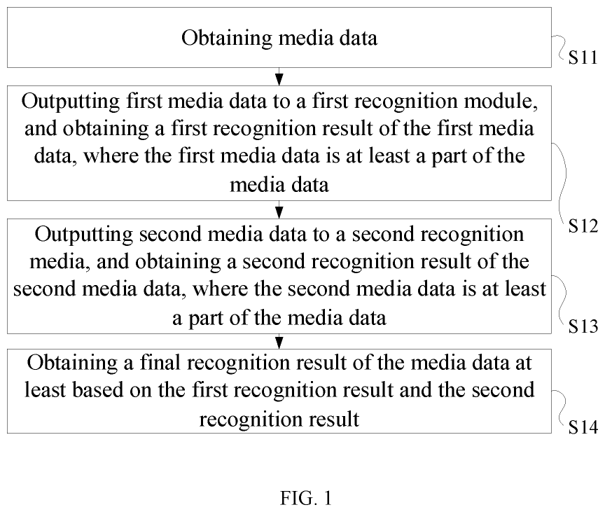

FIG. 1 illustrates a flow chart of a processing method according to some embodiments of the present disclosure. As shown in FIG. 1, the processing method includes:

S11, obtaining media data. The apparatus for obtaining the media data may include an audio collection device, and the audio collection device may be, for example, a microphone, for collecting audio data. In some embodiments, the apparatus for obtaining media data may include a communication device, and the communication device is configured to communicate with the audio collection device so that the communication device can receive the media data output by the audio collection device. The obtaining media data may be executed at the back end or at the server. For example, the back end or the server may receive the media data output by the apparatus, where the apparatus includes a microphone. The media data may be speech data, or music data.

S12, outputting first media data to a first recognition module, and obtaining a first recognition result of the first media data, where the first media data is at least a part of the media data.

That is, after obtaining the media data, at least a part of the media data may be treated as the first media data. The first media data may be sent to the first recognition module for recognition by the first recognition module, thus obtaining the first recognition result from the first recognition module.

In some embodiments, recognition by the first recognition module may include: recognizing, by the first recognition module, semantic meaning of the first media data, thereby determining a meaning of the content expressed by the first media data. In some embodiments, the first recognition module may recognize a tone of the first media data, and recognition by the first recognition module may correspondingly include: recognizing, by the first recognition module, a tone of the first media data, to determine sender information of the first media data. In some embodiments, the first recognition module may recognize a volume of the first media data, and recognition by the first recognition module may correspondingly include: recognizing, by the first recognition module, a volume of the first media data, to determine whether or not the volume needs to be adjusted. In some embodiments, the first recognition module may recognize two or more of the three parameters: semantic meaning, tone, and volume of the first media data, and recognition by the first recognition module may correspondingly include: recognizing, by the first recognition module, two or more of the three parameters: semantic meaning, tone, and volume of the second media data. The first recognition module may also be configured to recognize other parameters of the first media data, which is not limited thereto.

S13, outputting second media data to a second recognition module, and obtaining a second recognition result of the second media data, where the second media data is at least a part of the media data.

That is, after obtaining the media data, at least a part of the media data may be treated as second media data, and the second media data may be sent to the second recognition module for recognition by the second recognition module. The second recognition module may recognize the second media data to obtain a second recognition result.

In some embodiments, recognition by the second recognition module may include: recognizing, by the second recognition module, semantic meaning of the second media data, to determine a meaning of the content expressed by the second media data. In some embodiments, the second recognition module may recognize a tone of the second media data, and recognition by the second recognition module may include: recognizing, by the second recognition module, a tone of the second media data, to determine sender information of the second media data. In some embodiments, the second recognition module may recognize a volume of the second media data, and recognition by the second recognition module may correspondingly include: recognizing, by the second recognition module, a volume of the second media data, to determine whether or not the volume needs to be adjusted. In some embodiments, the second recognition module may recognize two or more of the three parameters: semantic meaning, tone, and volume of the second media data, and recognition by the second recognition module may correspondingly include: recognizing, by the second recognition module, two or more of the three parameters: semantic meaning, tone, and volume of the second media data. The second recognition module may also be configured to recognize other parameters of the second media data, which is not limited thereto.

In some embodiments, outputting the first media data to the first recognition module and outputting the second media data to the second recognition module may be performed simultaneously or in a certain order. Further, recognizing, by the first recognition module, the first media data, and recognizing, by the second recognition module, the second media data, may be performed simultaneously or in a certain order. Further, obtaining the first recognition result of the first media data and obtaining the second recognition result of the second media data may be performed simultaneously or in a certain order.

In some embodiments, the first media data output to the first recognition module may be the same as or different from the second media data output to the second recognition module. That is, the first media data recognized by the first recognition module may be the same as or different from the second media data recognized by the second recognition module.

In some embodiments, the first recognition module and the second recognition module may be configured to recognize the same parameters of the media data. The first recognition module and the second recognition module may also be configured to recognize different parameters of the media data.

For example, the first recognition module may recognize the semantic meaning of the first media data, and the second recognition module may recognize the tone of the second media data. In another example, the first recognition module may recognize the semantic meaning of the first media data, and the second recognition module may recognize the semantic meaning of the second media data.

In some embodiments, the media data recognized by the first recognition module and the media data recognized by the second recognition module may be the same or different. That is, the first media data may be the same as the second media data, or the first media data may be different from the second media data.

When different recognition modules are configured to recognize the same media data, the same media data may be output to different recognition modules simultaneously so that the different recognition modules may recognize the same media data simultaneously, or the same media data may be output to the different recognition modules in a certain order. Similarly, when different recognition modules are configured to recognize different media data, the different media data may be output to different recognition modules simultaneously so that the different recognition modules may recognize the different media data simultaneously, or the different media data may be output to the different recognition modules in a certain order.

Accordingly, the media data and parameters of the media data recognized by the first recognition module may be the same as or different from that recognized by the second recognition module.

For example, the first recognition module is configured to recognize the semantic meaning of the first media data, and the second recognition module is configured to recognize the semantic meaning of the second media data, where the first media data is the same as the first media data. In another example, the first recognition module is configured to recognize the semantic meaning of the first media data, and the second recognition module is configured to recognize the semantic meaning of the second media data, where the first media data is different from the second media data. In further another example, the first recognition module is configured to recognize the semantic meaning of the first media data, and the second recognition module is configured to recognize the volume of the first media data. In further another example, the first recognition module is configured to recognize the semantic meaning of the first media data, and the second recognition module is configured to recognize the volume of the second media data.

In some embodiments, the media data may merely include the first media data and the second media data, where the first media data is different from the second media data. In some embodiments, the media data may include media data other than the first media data and the second media data. For example, the media data may include the first media data, the second media data, and the third media data, where the first media data, the second media data, and the third media data are different from each other. In some embodiments, the media data may be the first media data or the second media data. For example, the first media data may be the media data, while the second media data is a part of the media data. Or, the second media data may be the media data, while the first media data is a part of the media data. In some embodiments, the first media data may be the same as the second media data, which forms the media data. That is, the first media data and the second media data can individually be the media data, instead of each being a part of the media data.

When the media data includes media data other than the first media data and the second media data, other recognition modules such as a third recognition module may be needed for recognizing the third media data. The parameters of the media data recognized by the third recognition module and the second recognition module may be the same or different, and the parameters of the media data recognized by the third recognition module and the first recognition module may be the same or different. The first media data, the second media data, and the third media may be the same or different from each other.

For example, the first media data, the second media data, and the third media data may be different from each other, and the parameters of the media data recognizable by the first recognition module, the second recognition module, and the third recognition module may be different. In one embodiment, the first recognition module, the second recognition module, and the third recognition module are respectively configured to recognize the semantic meaning of corresponding media data. If the first media data is a Chinese audio, the second media data is an English audio, and the third media data is a French audio, the first recognition module may be configured to translate the Chinese audio, the second recognition module may be configured to translate the English audio, and the third recognition module may be configured to translate the French audio, thereby obtaining corresponding translation results.

The number of the recognition modules is not limited to 1, 2, or 3. For example, the number of the recognition modules may be 4 or 5, and the present disclosure is not limited thereto.

S14, obtaining a final recognition result of the media data at least based on the first recognition result and the second recognition result.

When there are two recognition modules, two recognition results are correspondingly obtained. By analyzing the two recognition results, the recognition result of the media data is obtained. When there are three recognition modules, three recognition results are correspondingly obtained. By analyzing the three recognition results, the recognition result of the media data is obtained.

When analyzing at least two recognition results, the manner of analysis is related to the media data and the parameters of the media data to be recognized by the at least two recognition modules.

In some embodiments, all the recognition modules of the at least two recognition modules are configured to recognize the same media data. For example, when the at least two recognition modules are all configured to recognize the media data, and the parameters of the media data recognized by the at least two recognition modules are the same (e.g., all being the volume or tone), the analysis process may include: comparing the at least two recognition results obtained by the at least two recognition modules to obtain a final recognition result. In another example, when the at least two recognition modules are all configured to recognize the same media data, but the parameters of the media data recognized by the at least two recognition modules are different, the analysis process may include: combining the at least two recognition results obtained by the at least two recognition modules to determine a final recognition result. In some embodiments, if the at least two recognition modules are configured to recognize different media data and the parameters of the media data recognized by the at least two recognition modules are different, the analysis process may include: combining the at least two recognition results obtained by the at least two recognition modules, or if the at least two recognition results obtained by the at least two recognition modules are unrelated, outputting the at least two recognition results directly without combination or comparison.

In some embodiments, when the at least recognition modules are configured to recognize different media data and different parameters of the different media data, the analysis process may include: obtaining the first recognition result by using the first recognition module to recognize a first part of the media data, obtaining the second recognition result by using the second recognition module to recognize a second part of the media data, and combining the first recognition result and the second recognition result to obtain a final recognition result of the media data.

In some embodiments, when the at least two recognition modules are configured to recognize the same media data and different parameters of the same media data, the analysis process may include: obtaining the first recognition result by using the first recognition module to recognize an entire part of the media data, obtaining the second recognition result by using the second recognition module to recognize an entire part of the media data, matching the first recognition result and the second recognition result to obtain a multi-language matching degree order, and determining the final recognition result of the media data based on the multi-language matching degree order.

For example, the media data may be a sentence including both Chinese and English. To translate such media data, the sentence may be sent to the first recognition module and the second recognition module (and maybe other recognition modules). That is, the first recognition module receives the entire part of the media data, the second recognition module receives the entire part of the media data, and the first and second recognition modules are configured to recognize the entire part of the media data. In one implementation, the media data is a sentence in both Chinese and English, i.e., Apple [symbol] [symbol] (meaning “what does Apple mean”), and two different recognition modules are configured to recognize the media data to obtain a first recognition result and a second recognition result. The first recognition result and the second recognition result are both translation of the entire part of the media data, and by matching the first recognition result and the second recognition result, a matching degree between the two recognition results is determined.

If the results translated by the at least two recognition modules are the same, the same recognition result is determined directly as the final recognition result. If the results translated by the at least two recognition modules are partially the same, the same part is determined and the differing parts are further recognized by other recognition modules, thereby obtaining a translation result having a highest matching degree. Optionally, based on translation records, the result recognized by the most accurate recognition module in translation may be used as the final recognition result. Optionally, the accuracy of different recognition modules in translating different languages is determined, and based on the accuracy, the final recognition result is determined. For example, for different recognition modules, the language each recognition module can most accurately translate is determined, and a translation result of the portion of the media data in the language that a recognition module can most accurately translate is obtained as a recognition result of the corresponding language. The final recognition result can thus be obtained by combining the recognition results of the corresponding languages.

In some embodiments, if the first recognition module can most accurately translate Chinese and the second recognition module can mostly accurately translate English. From the first recognition result, the translation result of the Chinese portion of the media data is treated as the recognition result of the Chinese language. From the second recognition result, the translation result of the English portion of the media data is treated as the recognition result of the English language. The recognition result of the Chinese language and the recognition result of the English language are thus combined to obtain the final recognition result.

In the disclosed processing method, media data is obtained, and first media data is outputted to the first recognition module to obtain the first recognition result of the first media data, where the first media data is at least a part of the media data. Second media data is outputted to the second recognition module to obtain the second recognition result of the second media data, where the second media data is at least a part of the media data. The final recognition result of the media data may be obtained at least based on the first recognition result and the second recognition result. According to the present disclosure, by recognizing the media data respectively through the first recognition module and the second recognition module, the recognition of multiple languages is realized, which enhances the user experience.

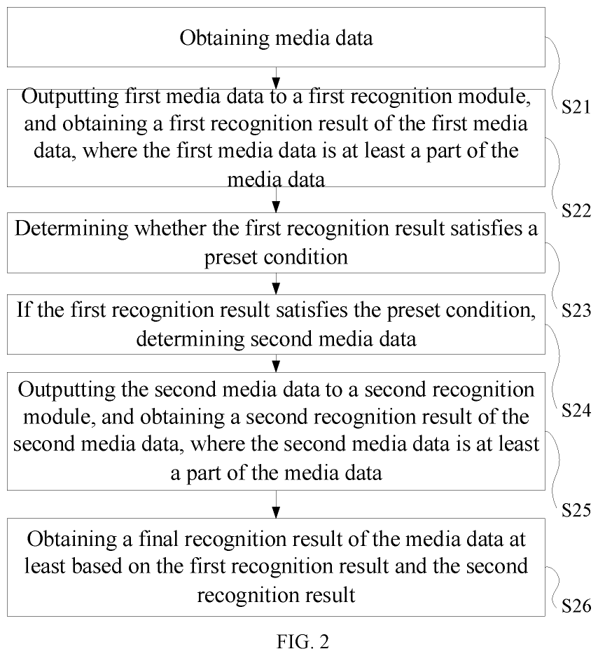

FIG. 2 illustrates a flow chart of a processing method according to some embodiments of the present disclosure. As shown in FIG. 2, the present disclosure provides a processing method, including:

S21, obtaining media data;

S22, outputting first media data to a first recognition module, and obtaining a first recognition result of the first media data, where the first media data is at least a part of the media data;

S23, determining whether the first recognition result satisfies a preset condition;

S24, if the first recognition result satisfies the preset condition, determining second media data;

S25, outputting the second media data to a second recognition module, and obtaining a second recognition result of the second media data, where the second media data is at least a part of the media data.

That is, the first media data is outputted to the first recognition module until the first recognition module obtains the first recognition result, and based on the first recognition result, whether the second media data needs to be outputted to the second recognition module is determined. In this example, the first and second media data is not sent to different recognition modules simultaneously but is sent in a certain order. Further, the certain order is based on the first recognition result of the first recognition module.

When the first recognition result satisfies the preset condition, the second media data needs to be outputted to the second recognition module can then be determined, and the second media data is outputted to the second recognition module. That is, whether the second media data is utilized is related to the first recognition result.

In the present disclosure, the first media data output to the first recognition module may be the same as or different from the media data. For example, the first media data is the same as the media data, and the media data is outputted to the first recognition module for the first recognition module to recognize the media data. When it is determined that the media data satisfies the preset condition, the second media data is outputted to the second recognition module. When it is determined that the media data does not satisfy the present condition, the second media data no longer needs to be determined, and no data needs to be transmitted to the second recognition module.

When the first media data satisfies the preset condition, it is indicated that the first recognition module cannot accurately recognize the first media data, or the first recognition module is unable to completely recognize the first media data. In this situation, other recognition modules are needed to realize the recognition of the entire media data. When the first media data does not satisfy the preset condition, it is indicated that the first recognition module can accurately and completely recognize the first media data. In such situation, other recognition module(s) are no longer needed for recognition.

In some embodiments, the present condition may include identifying a keyword in the first recognition result. That is, when the first recognition result includes a keyword, the second media data is needed for purpose of recognition.

The keyword may be a keyword indicating that the first media data or the media data include other types of languages.

The “another type of language” may be a different language or a term of certain type. The term of certain type may be a term that designates a scene, such as a term that designates a site, a term that designates a person or an object, a term that designates an application, or a term that designates a webpage. The term that designates a site may include: hotel and scenic area. The term that designates a person or an object may include: lovely and body. The term that designates an application may include: operate, uninstall, upgrade, and start. The term that designates a webpage may include: website, and refresh.

For example, the media data may be “ [symbol] Burj Al Arab [symbol] ” (meaning “help me book a room at hotel Burj Al Arab” in English), and “ [symbol] ” (meaning “hotel”) in the media data may be determined as a term that designates a scene. The second media data is thus determined, which can be “ [symbol] Burj Al Arab [symbol] [symbol] ” or “Burj Al Arab,” and the second media data may be output to the second recognition module. When the second media data is “ [symbol] Burj Al Arab [symbol] [symbol] ,” the final recognition result is obtained by comparing the first recognition result and the second recognition result, where the first recognition result may be “ [symbol] XXX [symbol] ” (meaning “help me book a room at hotel XXX”) and the second recognition result may be a sentence including the designated term “ [symbol] ” (meaning “Burj Al Arab”). In this implementation, the second recognition module is configured to translate the second media data from English to Chinese. When the second media data is “Burj Al Arab,” the second recognition result may also be data or webpage relating to “Burj Al Arab,” obtained through searching. Optionally, the second recognition module may perform other recognition operations on the second media data, which is not limited thereto.

When comparing the first recognition result and the second recognition result, if the second recognition module performs translation on the second media data, the final recognition result may be “ [symbol] [symbol] ” (meaning “help me book a room at hotel “Burj Al Arab”). If the second recognition module performs searching on the second media data, the final recognition result may be a combination of the first recognition result and the second recognition result, i.e., a combination of “ [symbol] XXX [symbol] ” (meaning “help me book a room at hotel XXX”) and a searching result relating to “Burj Al Arab.”

In one embodiment, taking the second media data translated by the second recognition module as an example, when the second media data is “Burj Al Arab,” the final recognition result is the result by combining the first recognition result and the second recognition result. The first recognition result is “ [symbol] XXX [symbol] ” and at this moment, “XXX” in the first recognition result may be determined as the word of the second language. Therefore, “Burj Al Arab” is output as the second media data, and the second recognition result only includes “ [symbol] ” (meaning “Burj Al Arab”). The final recognition result can be “ [symbol] [symbol] ” (meaning “help me book a room at hotel Burj Al Arab”).

The keyword may also be data in the first recognition result that cannot be recognized by the first recognition module.

The data cannot be recognized by the first recognition module may include: no data, or illogical data.

For example, if the first recognition module is configured to recognize Chinese language, the first recognition module may not recognize English words such as “Apple.” In another example, the first recognition result may be “ [symbol] [symbol] ” (meaning “what is the comparative of Gude”), which is illogical data.

After determining that the first recognition result includes data that cannot by recognized by the first recognition module, the data that cannot by recognized by the first recognition module may be output to other recognition module(s). For example, the data that cannot by recognized by the first recognition module may be treated as the second media data, to be recognized by one or more of the other recognition modules.

Obtaining the final recognition result of the media data at least based on the first recognition result and the second recognition result may include: determining a location of data unrecognizable by the first recognition module in the first recognition result, and placing the second recognition result in the location of the data unrecognizable by the first recognition module in the first recognition result, thereby obtaining the final recognition result of the media data.

For example, the first media data may be “Apple [symbol] ” (meaning “what is the plural noun of Apple”), and the first recognition module cannot recognize the English word “Apple.” The word “Apple” may then output as the second media data to the second recognition module to obtain the second recognition result “ [symbol] ” (meaning “apple”). Further, the first recognition result and the second recognition result may be combined, and when combining the first recognition result and the second recognition result, the location of the data unrecognizable by the first recognition module in the first recognition result may be determined. In this example, the location of the word “Apple” in the first recognition result is determined, and after the second recognition result is obtained as “ [symbol] ” (meaning “apple”), the Chinese term “ [symbol] ” may be placed in the location of the English word “Apple” in the first recognition result. Accordingly, the first recognition result is combined with the second recognition result, thereby obtaining the final recognition result.

In some embodiments, after determining that the first recognition result include data unrecognizable by the first recognition module, the entire first media data may be output to other recognition modules. That is, the first media data may be the same as the second media data, or other media data.

In some embodiments, the first media data may be “Good [symbol] ” (meaning “what is the comparative of Good”), and the first recognition module may recognize the first media data to obtain the first recognition result as “ [symbol] [symbol] ” (meaning “what is the comparative of Gude”), which belongs to an illogical sentence. In such situation, the first media data is treated as the second media data for output to the second recognition module, thereby obtaining the second recognition result.

Further, determining whether the first recognition result includes a keyword may be determined by the first recognition module. Similarly, determining whether the first recognition result includes data unrecognizable by the first recognition module may also be determined by the first recognition module. That is, the first recognition module may be configured to determine whether the first recognition result satisfies the preset condition.

S26, obtaining a final recognition result of the media data at least based on the first recognition result and the second recognition result.

In the disclosed processing method, media data is obtained, and first media data is outputted to the first recognition module to obtain the first recognition result of the first media data, where the first media data is at least a part of the media data. Second media data is outputted to the second recognition module to obtain the second recognition result of the second media data, where the second media data is at least a part of the media data. The recognition result of the media data may be obtained at least based on the first recognition result and the second recognition result. In the present disclosure, by recognizing the media data respectively through the first recognition module and the second recognition module, the recognition of multiple languages is realized, which enhances the user experience.

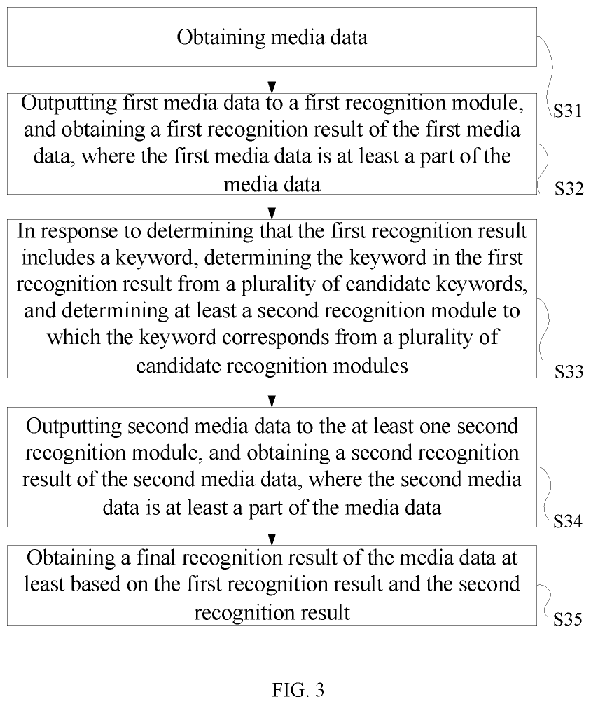

FIG. 3 illustrates a flow chart of a processing method according to some embodiments of the present disclosure. As shown in FIG. 3, the processing method includes:

S31, obtaining media data;

S32, outputting first media data to a first recognition module, and obtaining a first recognition result of the first media data, where the first media data is at least a part of the media data;

S33, in response to determining that the first recognition result includes a keyword, determining the keyword in the first recognition result from a plurality of candidate keywords, and determining at least a second recognition module to which the keyword corresponds from a plurality of candidate recognition modules;

S34, outputting second media data to the at least one second recognition module, and obtaining a second recognition result of the second media data, where the second media data is at least a part of the media data.

If the first recognition result includes a keyword, it is indicated that assistance from recognition modules other than the first recognition module is needed to accurately and completely recognize the first media data.

If there are a plurality of candidate keywords, there may be one or more recognition modules corresponding to the plurality of candidate keywords. When there is one recognition module corresponding to the plurality of candidate keywords, it is indicated that the media data including the plurality of candidate keywords can be recognized by the one recognition module. When there are multiple recognition modules corresponding to the plurality of candidate keywords (e.g., each candidate keyword corresponds to one recognition module), the media data including one or more candidate keywords needs one or more corresponding recognition modules for recognition.

In one example, if a candidate keyword includes a term capable of showing the type of the language, the type of the language may be configured to determine a corresponding recognition module.

The terms capable of showing the type of the language may include: [symbol] (meaning “comparative”), [symbol] (meaning “superlative”), [symbol] (meaning “katakana”), [symbol] (meaning “hiragana”), [symbol] (meaning “feminine”), [symbol] (meaning “masculine”), [symbol] (meaning “neutral”).

Terms such as [symbol] (meaning “comparative”) and [symbol] (meaning “superlative”) are often seen in English or French. Terms such as [symbol] (meaning “katakana”) and [symbol] (meaning “hiragana”) are often seen in Japanese. Terms such as [symbol] (meaning “feminine”), [symbol] (meaning “masculine”), and [symbol] (meaning “neutral”) are often found in German. Accordingly, the candidate keywords can correspond to a plurality of recognition modules. For example, the terms such as [symbol] (meaning “comparative”) and [symbol] (meaning “superlative”) may be configured to correspond to an English recognition module and a French recognition module. The terms such as A [symbol] [symbol] (meaning “katakana”) and [symbol] (meaning “hiragana”) may be configured to correspond to a Japanese recognition module. The terms such as [symbol] (meaning “feminine”), [symbol] (meaning “masculine”), and [symbol] (meaning “neutral”) may be configured to correspond to a German recognition module.

In one example, the first recognition result includes a keyword “ [symbol] ” (meaning “comparative”), and the candidate keywords include the keyword “ [symbol] ” Accordingly, the recognition module corresponding to the keyword “ [symbol] ” may be determined as the second recognition module, and the second recognition module may be an English recognition module, or a French recognition module. Or, two different recognition modules may be determined, including the English recognition module and the French recognition module, thereby ensuring that the media data can be accurately recognized.

In some embodiments, if the candidate keywords include an explicitly orientated term, a corresponding recognition module may be determined based on the explicitly orientated term.

The explicitly orientated term may be, for example, a term such as [symbol] (meaning “Japanese”) or “ [symbol] ” (meaning “English”). When an explicitly orientated term appears, the keyword “ [symbol] ” is directed to the Japanese recognition module, and the keyword “ [symbol] [symbol] ” is directed to the English recognition module.

S35, obtaining a final recognition result of the media data at least based on the first recognition result and the second recognition result.

In the disclosed processing method, media data is obtained, and first media data is outputted to the first recognition module to obtain the first recognition result of the first media data, where the first media data is at least a part of the media data. Second media data is outputted to the second recognition module to obtain the second recognition result of the second media data, where the second media data is at least a part of the media data. The recognition result of the media data may be obtained at least based on the first recognition result and the second recognition result. In the present disclosure, by recognizing the media data respectively through the first recognition module and the second recognition module, the recognition of multiple languages is realized, which enhances the user experience.

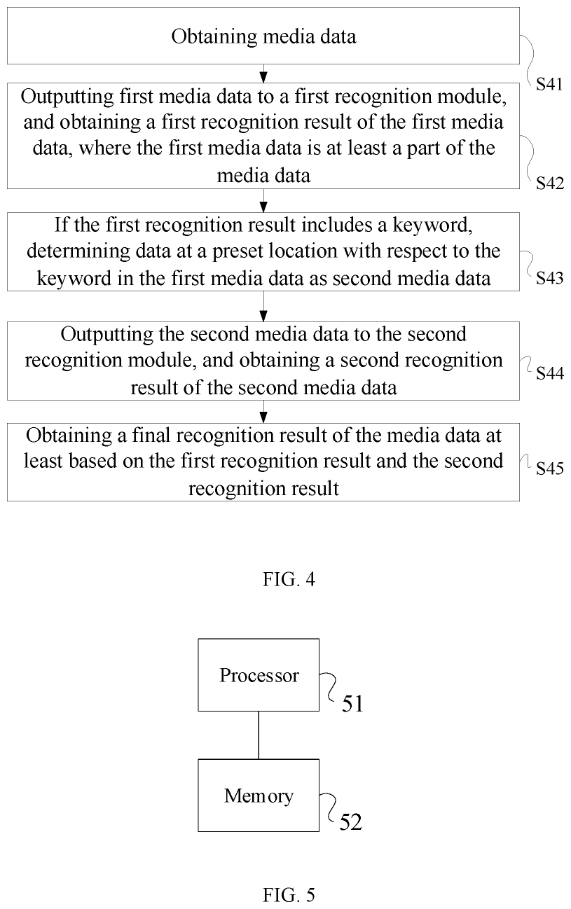

FIG. 4 illustrates a flow chart of a processing method according to some embodiments of the present disclosure. As shown in FIG. 4, the processing method includes:

S41, obtaining media data;

S42, outputting first media data to a first recognition module, and obtaining a first recognition result of the first media data, where the first media data is at least a part of the media data;

S43, if the first recognition result includes a keyword, determining data at a preset location with respect to the keyword in the first media data as second media data.

If the first recognition result is determined to include a keyword, based on a preset location with respect to the keyword, the term(s) at the preset location with respect to the keyword may be determined from the first media data, and such term(s) are determined as the second media data.

For example, when the first media data is “ [symbol] Burj Al Arab [symbol] ” (meaning “help me book a room at hotel Burj Al Arab”), the first recognition module may perform recognition on the first media data to obtain the first recognition result, i.e., “ [symbol] XXX [symbol] ” (meaning “help me book a room at hotel XXX”). In this example, the keyword is “ [symbol] ” (meaning “hotel”), and the preset location of the keyword “ [symbol] ” may be configured to be a preset number of terms immediately preceding the keyword “ [symbol] .” For example, if the preset number is 3, the second media data is “Burj Al Arab” and the second recognition module performs recognition on the second media data.

Further, obtaining the final recognition result of the media data at least based on the first recognition result and the second recognition result may include: determining a preset location with respect to the keyword in the first recognition result, and placing the second recognition result in the preset location with respect to the keyword in the first recognition result, thereby obtaining the final recognition result of the media data.

Further, because the second media data is obtained from a location in the first media data that corresponds to the preset location with respect to the keyword, by placing the second recognition result recognized by the second media data into the preset location that corresponds to the location where the second media data is extracted, namely, the preset location with respect to the keyword in the first recognition result, the combination of the first recognition result and the second recognition result is realized.

For example, the first recognition result may be “ [symbol] XXX [symbol] ” (meaning “help me book a room at hotel XXX”), which includes the keyword “ [symbol] ” (meaning “hotel”). The terms at a preset location with respect to the keyword is “XXX,” and the terms (i.e., “Burj Al Arab”) in a location of the first media data that corresponds to the present location may be treated as the second media data. The second media data may be recognized to obtain the second recognition result “ [symbol] ” (meaning “Burj Al Arab”), and the second recognition result “ [symbol] ” is placed at the location of “XXX” in the first recognition result to replace “XXX.” Accordingly, the final recognition result is obtained.

In some embodiments, the first media data may be the same as or different from the media data. For example, terms other than “XXX” in the sentence “ [symbol] XXX [symbol] ” may be used as the first media data, and the location of “XXX” may be replaced with the same number of spaces. If the first media data is different from the media data, the media data needs to be checked to determine the terms in the media data recognizable by the first recognition module. The terms recognizable by the first recognition module may be used as the first media data.

S44, outputting the second media data to the second recognition module, and obtaining a second recognition result of the second media data;

S45, obtaining a final recognition result of the media data at least based on the first recognition result and the second recognition result.

In the disclosed processing method, media data is obtained, and first media data is outputted to the first recognition module to obtain the first recognition result of the first media data, where the first media data is at least a part of the media data. Second media data is outputted to the second recognition module to obtain the second recognition result of the second media data, where the second media data is at least a part of the media data. The recognition result of the media data may be obtained at least based on the first recognition result and the second recognition result. In the present disclosure, by recognizing the media data respectively through the first recognition module and the second recognition module, the recognition of multiple languages is realized, which enhances the user experience.

FIG. 5 illustrates a structural schematic view of an electronic apparatus according to some embodiments of the present disclosure. As shown in FIG. 5, the electronic apparatus includes a processor 51 and a memory 52.

The processor 51 is configured for obtaining media data, outputting first media data to a first recognition module, and obtaining a first recognition result of the first media data, where the first media data is at least a part of the media data. The processor 51 is further configured for outputting second media data to a second recognition module, and obtaining a second recognition result of the second media data, where the second media data is at least a part of the media data. The processor 51 is further configured for obtaining a final recognition result of the media data at least based on the first recognition result and the second recognition result.

The memory 52 is configured to store the first recognition result, the second recognition result and the final recognition result.

For the electronic apparatus to obtain the media data, the electronic apparatus may include an audio collection device. The audio collection device may be, for example, a microphone, for collecting audio data. In another embodiment, the electronic apparatus may include a communication device, and the communication device may communicate with the audio collection device so that the communication device can receive the media data output by the audio collection device. The media data may be speech data, or music data.

After obtaining the media data, at least a part of the media data may be obtained as the first media data. The first media data may be sent to the first recognition module for recognition by the first recognition module, thus obtaining the first recognition result from the first recognition module.

In some embodiments, recognition by the first recognition module may include: recognizing, by the first recognition module, semantic meaning of the first media data, to determine a meaning of the content expressed by the first media data. In some embodiments, the first recognition module may recognize a tone of the first media data, and recognition by the first recognition module may include: recognizing, by the first recognition module, a tone of the first media data, to determine sender information of the first media data. In some embodiments, the first recognition module may recognize a volume of the first media data, and recognition by the first recognition module may include: recognizing, by the first recognition module, a volume of the first media data, to determine whether or not the volume needs to be adjusted. In some embodiments, the first recognition module may recognize two or more of the three parameters: semantic meaning, tone, and volume of the first media data, and the first recognition result may correspondingly include two or more of the semantic meaning, the tone, and the volume of the first media data. The first recognition module may be configured to recognize other parameters of the first media data, which is not limited thereto.

After obtaining the media data, at least a part of the media data may be obtained as second media data, and the second media data may be sent to the second recognition module for recognition by the second recognition module. The second recognition module may recognize the second media data to provide a second recognition result.

In some embodiments, recognition by the second recognition module may include: recognizing, by the second recognition module, semantic meaning of the second media data, to determine a meaning of the content expressed by the second media data. In some embodiments, the second recognition module may recognize a tone of the second media data, and recognition by the second recognition module may include: recognizing, by the second recognition module, a tone of the second media data, to determine sender information of the second media data. In some embodiments, the second recognition module may recognize a volume of the second media data, and recognition by the second recognition module may correspondingly include: recognizing, by the second recognition module, a volume of the second media data, to determine whether or not the volume needs to be adjusted. In some embodiments, the second recognition module may recognize two or more of the three parameters: semantic meaning, tone, and volume of the second media data, and recognition by the second recognition module may correspondingly include: recognizing, by the second recognition module, two or more of the three parameters: semantic meaning, tone, and volume of the second media data. The second recognition module may also be configured to recognize other parameters of the second media data, which is not limited thereto.

In some embodiments, outputting the first media data to the first recognition module and outputting the second media data to the second recognition module may be performed simultaneously or in a certain order. Further, recognizing, by the first recognition module, the first media data, and recognizing, by the second recognition module, the second media data, may be performed simultaneously or in a certain order. Further, obtaining the first recognition result of the first media data and obtaining the second recognition result of the second media data may be performed simultaneously or in a certain order.

In some embodiments, the first media data output to the first recognition module may be the same as or different from the second media data output to the second recognition module. That is, the first media data recognized by the first recognition module may be the same as or different from the second media data recognized by the second recognition module.

In some embodiments, the first recognition module and the second recognition module may recognize the same parameters of the media data or different parameters of the media data.

For example, the first recognition module may recognize the semantic meaning of the first media data, and the second recognition module may recognize the tone of the second media data. In another example, the first recognition module may recognize the semantic meaning of the first media data, and the second recognition module may recognize the semantic meaning of the second media data.

In some embodiments, the media data recognized by the first recognition module and the second recognition module may be the same or different. That is, the first media data may be the same as the second media data, or the first media data may be different from the second media data.

When different recognition modules are configured to recognize the same media data, the same media data may be output to different recognition modules simultaneously so that the different recognition modules may recognize the same media data simultaneously, or the same media data may be output to the different recognition modules in a certain order. Similarly, when different recognition modules are configured to recognize different media data, the different media data may be output to different recognition modules simultaneously so that the different recognition modules may recognize the different media data simultaneously, or the different media data may be output to the different recognition modules in a certain order.

Accordingly, the media data and parameters of the media data recognized by the first recognition module may be the same as or different from that recognized by the second recognition module.

For example, the first recognition module is configured to recognize the semantic meaning of the first media data, and the second recognition module is configured to recognize the semantic meaning of the second media data, where the first media data is the same as the first media data. In another example, the first recognition module is configured to recognize the semantic meaning of the first media data, and the second recognition module is configured to recognize the semantic meaning of the second media data, where the first media data is different from the second media data. In further another example, the first recognition module is configured to recognize the semantic meaning of the first media data, and the second recognition module is configured to recognize the volume of the first media data. In further another example, the first recognition module is configured to recognize the semantic meaning of the first media data, and the second recognition module is configured to recognize the volume of the second media data.

In some embodiments, the media data may merely include the first media data and the second media data, where the first media data is different from the second media data. In some embodiments, the media data may include media data other than the first media data and the second media data. For example, the media data may include the first media data, the second media data, and the third media data, where the first media data, the second media data, and the third media data are different from each other. In some embodiments, the media data may be the first media data or the second media data. For example, the first media data may be the media data, while the second media data is part of the media data. Or, the second media data may be the media data, while the first media data is part of the media data. In some embodiments, the first media data may be the same as the second media data, which forms the media data. That is, the first media data and the second media data can individually be the media data, instead of each being a part of the media data.

When the media data includes media data other than the first media data and the second media data, other recognition modules such as a third recognition module may be needed for recognizing the third media data. The parameters of the media data recognized by the third recognition module and the second recognition module may be the same or different. The parameters of the media data recognized by the third recognition module and the first recognition module may be the same or different. The first media data, the second media data, and the third media may be the same or different from each other.

For example, the first media data, the second media data, and the third media data may be different from each other, and the parameters of the media data recognizable by the first recognition module, the second recognition module, and the third recognition module may be different. In one embodiment, the first recognition module, the second recognition module, and the third recognition module are respectively configured to recognize the semantic meaning of corresponding media data. If the first media data is a Chinese audio, the second media data is an English audio, and the third media data is a French audio, the first recognition module may be configured to translate the Chinese audio, the second recognition module may be configured to translate the English audio, and the third recognition module may be configured to translate the French audio, thereby obtaining corresponding translation results.

The number of the recognition modules is not limited to 1, 2, or 3. The number of the recognition modules may be, for example, 4 or 5. The present disclosure is not limited thereto.

When there are two recognition modules, two recognition results are correspondingly obtained. By analyzing the two recognition results, the recognition result of the media data is obtained. When there are three recognition modules, three recognition results are correspondingly obtained. By analyzing the three recognition results, the recognition result of the media data is obtained.

When analyzing at least two recognition results, the manner of analysis is related to the media data and the parameters of the media data to be recognized by the at least two recognition modules.

In some embodiments, all the recognition modules of the at least two recognition modules are configured to recognize the same media data. For example, when the at least two recognition modules are all configured to recognize the media data, and the parameters of the media data recognized by the at least two recognition modules are the same (e.g., all being the volume or tone), the analysis process may include: comparing the at least two recognition results obtained by the at least two recognition modules to obtain a final recognition result. In another example, when the at least two recognition modules are all configured to recognize the same media data, but the parameters of the media data recognized by the at least two recognition modules are different, the analysis process may include: combining the at least two recognition results obtained by the at least two recognition modules to determine a final recognition result. In some embodiments, if the at least two recognition modules are configured to recognize different media data and the parameters of the media data recognized by the at least two recognition modules are different, the analysis process may include: combining the at least two recognition results obtained by the at least two recognition modules, or if the at least two recognition results obtained by the at least two recognition modules are unrelated, outputting the at least two recognition results directly without combination or comparison.

In some embodiments, when the at least recognition modules are configured to recognize different media data and different parameters of the different media data, the analysis process may include: obtaining the first recognition result by using the first recognition module to recognize a first part of the media data, obtaining the second recognition result by using the second recognition module to recognize a second part of the media data, and combining the first recognition result and the second recognition result to obtain a final recognition result of the media data.

In some embodiments, when the at least two recognition modules are configured to recognize the same media data and different parameters of the same media data, the analysis process may include: obtaining the first recognition result by using the first recognition module to recognize an entire part of the media data, obtaining the second recognition result by using the second recognition module to recognize an entire part of the media data, matching the first recognition result and the second recognition result to obtain a multi-language matching degree order, and determining the final recognition result of the media data based on the multi-language matching degree order.

For example, the media data may be a sentence including both Chinese and English. To translate such media data, the sentence may be sent to the first recognition module and the second recognition module (and maybe other recognition modules). That is, the first recognition module receives the entire part of the media data, the second recognition module receives the entire part of the media data, and the first and second recognition modules are configured to recognize the entire part of the media data. In one implementation, the media data is a sentence in both Chinese and English, i.e., Apple [symbol] [symbol] (meaning “what does Apple mean”), and two different recognition modules are configured to recognize the media data to obtain a first recognition result and a second recognition result. The first recognition result and the second recognition result are both translation of the entire part of the media data, and by matching the first recognition result and the second recognition result, a matching degree between the two recognition results is determined.

If the results translated by the at least two recognition modules are the same, the same recognition result is determined directly as the final recognition result. If the results translated by the at least two recognition modules are partially the same, the same part is determined and the differing parts are further recognized by other recognition modules, thereby obtaining a translation result having a highest matching degree. Optionally, based on translation records, the result recognized by the most accurate recognition module in translation may be used as the final recognition result. Optionally, the accuracy of different recognition modules in translating different languages is determined, and based on the accuracy, the final recognition result is determined. For example, for different recognition modules, the language each recognition module can most accurately translate is determined, and a translation result of the portion of the media data in the language that a recognition module can most accurately translate is obtained as a recognition result of the corresponding language. The final recognition result can thus be obtained by combining the recognition results of the corresponding languages.

In some embodiments, if the first recognition module can most accurately translate Chinese and the second recognition module can mostly accurately translate English. From the first recognition result, the translation result of the Chinese portion of the media data is treated as the recognition result of the Chinese language. From the second recognition result, the translation result of the English portion of the media data is treated as the recognition result of the English language. The recognition result of the Chinese language and the recognition result of the English language are thus combined to obtain the final recognition result.

Outputting the second media data, by the processor 51, to the second recognition module may include: determining, by the processor 51, whether the first recognition result satisfies a preset condition. If the first recognition result satisfies the preset condition, the processor 51 determines second media data and outputs the second media data to a second recognition module.

That is, the first media data is outputted to the first recognition module until the first recognition module obtains the first recognition result, and based on the first recognition result, whether the second media data needs to be outputted to the second recognition module is determined. In this example, the first and second media data is not sent to different recognition modules simultaneously but is sent in a certain order. Further, the certain order is based on the first recognition result of the first recognition module.

When the first recognition result satisfies the preset condition, the second media data needs to be outputted to the second recognition module can then be determined, and the second media data is outputted to the second recognition module. That is, whether the second media data is utilized is related to the first recognition result.

In the present disclosure, the first media data output to the first recognition module may be the same as or different from the media data. For example, the first media data is the same as the media data, and the media data is outputted to the first recognition module for the first recognition module to recognize the media data. When it is determined that the media data satisfies the preset condition, the second media data is outputted to the second recognition module. When it is determined that the media data does not satisfy the present condition, the second media data no longer needs to be determined, and no data needs to be transmitted to the second recognition module.

When the first media data satisfies the preset condition, it is indicated that the first recognition module cannot accurately recognize the first media data, or the first recognition module is unable to completely recognize the first media data. In this situation, other recognition modules are needed to realize the recognition of the entire media data. When the first media data does not satisfy the preset condition, it is indicated that the first recognition module can accurately and completely recognize the first media data. In such situation, other recognition module(s) are no longer needed for recognition.

In some embodiments, the present condition may include: identifying a keyword in the first recognition result. That is, when the first recognition result includes a keyword, the second media data is needed for purpose of recognition.

The keyword may be a keyword indicating that the first media data or the media data include other types of languages.

The “another type of language” may be a different language or a term of certain type. The term of certain type may be a term that designates a scene, such as a term that designates a site, a term that designates a person or an object, a term that designates an application, or a term that designates a webpage. The term that designates a site may include: hotel and scenic area. The term that designates a person or an object may include: lovely and body. The term that designates an application may include: operate, uninstall, upgrade, and start. The term that designates a webpage may include: website, and refresh.

For example, the media data may be “ [symbol] Burj Al Arab [symbol] ” (meaning “help me book a room at hotel Burj Al Arab” in English), and “ [symbol] ” (meaning “hotel”) in the media data may be determined as a term that designates a scene. The second media data is thus determined, which can be “ [symbol] Burj Al Arab [symbol] [symbol] ” or “Burj Al Arab,” and the second media data may be output to the second recognition module. When the second media data is “ [symbol] Burj Al Arab [symbol] [symbol] ,” the final recognition result is obtained by comparing the first recognition result and the second recognition result, where the first recognition result may be “ [symbol] XXX [symbol] ” (meaning “help me book a room at hotel XXX”) and the second recognition result may be a sentence including the designated term “ [symbol] ” (meaning “Burj Al Arab”). In this implementation, the second recognition module is configured to translate the second media data from English to Chinese. When the second media data is “Burj Al Arab,” the second recognition result may also be data or webpage relating to “Burj Al Arab,” obtained through searching. Optionally, the second recognition module may perform other recognition operations on the second media data, which is not limited thereto.

When comparing the first recognition result and the second recognition result, if the second recognition module performs translation on the second media data, the final recognition result may be “ [symbol] [symbol] ” (meaning “help me book a room at the hotel Burj Al Arab”). If the second recognition module performs search on the second media data, the final recognition result may be a combination of the first recognition result and the second recognition result, i.e., a combination of “ [symbol] XXX [symbol] ” (meaning “help me book a room at hotel XXX”) and search result relating to “Burj Al Arab.”

In one embodiment, taking the second media data translated by the second recognition module as an example, when the second media data is “Burj Al Arab”, the final recognition result is the result by combining the first recognition result and the second recognition result. The first recognition result is “ [symbol] XXX [symbol] ” and at this moment, “XXX” in the first recognition result may be determined as the word of the second language. Therefore, “Burj Al Arab” is output as the second media data, and the second recognition result only includes “ [symbol] ” (meaning “Burj Al Arab”). The final recognition result can be “ [symbol] [symbol] ” (meaning “help me book a room at hotel Burj Al Arab”).

The keyword may also be data in the first recognition result that cannot be recognized by the first recognition module.

The data cannot be recognized by the first recognition module may include: no data, or illogical data.

For example, if the first recognition module is configured to recognize only Chinese language, the first recognition module may not recognize English words such as “Apple.” In another example, the first recognition result may be “ [symbol] [symbol] ” (meaning “what is the comparative of Gu De”), which is illogical data.

After determining that the first recognition result include data that cannot by recognized by the first recognition module, the data that cannot by recognized by the first recognition module may be output to other recognition module. For example, the data that cannot by recognized by the first recognition module may be treated as the second media data, to be recognized by one or more of the other recognition modules.

Obtaining the final recognition result of the media data at least based on the first recognition result and the second recognition result may include: determining a location of data unrecognizable by the first recognition module in the first recognition result, and placing the second recognition result in the location of the data unrecognizable by the first recognition module in the first recognition result, thereby obtaining the final recognition result of the media data.

For example, the first media data may be “Apple [symbol] ” (meaning “what is the plural noun of Apple”), and the first recognition module cannot recognize the English word “Apple.” The word “Apple” may then output as the second media data to the second recognition module to obtain the second recognition result “ [symbol] ” (meaning “apple”). Further, the first recognition result and the second recognition result may be combined, and when combining the first recognition result and the second recognition result, the location of the data unrecognizable by the first recognition module in the first recognition result may be determined. In this example, the location of the word “Apple” in the first recognition result is determined, and after the second recognition result is obtained as “ [symbol] ” (meaning “apple”), the Chinese term “ [symbol] ” may be placed in the location of the English word “Apple” in the first recognition result. Accordingly, the first recognition result is combined with the second recognition result, thereby obtaining the final recognition result.

In some embodiments, after determining the first recognition result include data unrecognizable by the first recognition module, the entire first media data may be output to other recognition modules. That is, the first media data may be the same as the second media data, or other media data.

In some embodiments, the first media data may be “Good [symbol] ” (meaning “what is the comparative of Good”), and the first recognition module may recognize the first media data to obtain the first recognition result as “ [symbol] [symbol] ” (meaning “what is the comparative of Gude”), which belongs to an illogical sentence. In such situation, the first media data is treated as the second media data for output to the second recognition module, thereby obtaining the second recognition result.

Further, determining whether the first recognition result includes a keyword may be determined by the first recognition module. Similarly, determining whether the first recognition result includes data unrecognizable by the first recognition module may also be determined by the first recognition module. That is, the first recognition module may be configured to determine whether the first recognition result satisfies the preset condition.

In some embodiments, if the preset condition is identifying a keyword in the first recognition result, outputting, by the processor 51, the second media data to the second recognition module may include: determining the keyword in the first recognition result from a plurality of keyword candidates, determining at least a second recognition module to which the keyword corresponds from a plurality of candidate recognition modules, and outputting second media data to the at least one second recognition module. If the first recognition result includes a keyword, assistance from recognition modules other than the first recognition module is needed to accurately and completely recognize the first media data.

If there are a plurality of candidate keywords, there may be one or more recognition modules corresponding to the plurality of candidate keywords. When there is one recognition module corresponding to the plurality of candidate keywords, it is indicated that the media data including the plurality of candidate keywords can be recognized by the one recognition module. When there are multiple recognition modules corresponding to the plurality of candidate keywords (e.g., each candidate keyword corresponds to one recognition module), the media data including one or more candidate keywords needs one or more corresponding recognition modules for recognition.

In one example, if a candidate keyword includes a term capable of showing the type of the language, the type of the language may be configured to determine a corresponding recognition module.

The terms capable of showing the type of the language may include: [symbol] (meaning “comparative”), [symbol] (meaning “superlative”), [symbol] (meaning “katakana”), [symbol] (meaning “hiragana”), [symbol] (meaning “feminine”), [symbol] (meaning “masculine”), [symbol] (meaning “neutral”).

Terms such as [symbol] (meaning “comparative”) and [symbol] (meaning “superlative”) are often seen in English or French. Terms such as [symbol] (meaning “katakana”) and [symbol] (meaning “hiragana”) are often seen in Japanese. Terms such as [symbol] (meaning “feminine”), [symbol] (meaning “masculine”), and [symbol] (meaning “neutral”) are often found in German. Accordingly, the candidate keywords can correspond to a plurality of recognition modules. For example, the terms such as [symbol] (meaning “comparative”) and [symbol] (meaning “superlative”) may be configured to correspond to an English recognition module and a French recognition module. The terms such as A [symbol] [symbol] (meaning “katakana”) and [symbol] (meaning “hiragana”) may be configured to correspond to a Japanese recognition module. The terms such as [symbol] (meaning “feminine”), [symbol] (meaning “masculine”), and [symbol] (meaning “neutral”) may be configured to correspond to a German recognition module.

In one example, the first recognition result includes a keyword “ [symbol] ” (meaning “comparative”), and the candidate keywords include the keyword “ [symbol] ” Accordingly, the recognition module corresponding to the keyword “ [symbol] ” may be determined as the second recognition module, and the second recognition module may be an English recognition module, or a French recognition module. Or, two different recognition modules may be determined, including the English recognition module and the French recognition module, thereby ensuring that the media data can be accurately recognized.

In some embodiments, if the candidate keywords include an explicitly orientated term, a corresponding recognition module may be determined based on the explicitly orientated term.

The explicitly orientated term may be, for example, a term such as [symbol] (meaning “Japanese”) or [symbol] (meaning “English”). When an explicitly orientated term appears, the keyword “ [symbol] ” is directed to the Japanese recognition module, and the keyword “ [symbol] [symbol] ” is directed to the English recognition module.

If the preset condition is identifying a keyword in the first recognition result, the determining, by the processor 51, the second media data, may include: determining, by the processor 51, data at a preset location with respect to the keyword in the first media data as second media data.

If the first recognition result is determined to include a keyword, based on a preset location with respect to the keyword, the term(s) at the preset location with respect to the keyword may be determined from the first media data, and such term(s) are determined as the second media data.

For example, when the first media data is “ [symbol] Burj Al Arab [symbol] ” (meaning “help me book a room at hotel Burj Al Arab”), the first recognition module may perform recognition on the first media data to obtain the first recognition result, i.e., “ [symbol] XXX [symbol] ” (meaning “help me book a room at hotel XXX”). In this example, the keyword is “ [symbol] ” (meaning “hotel”), and the preset location of the keyword “ [symbol] ” may be configured to be a preset number of terms immediately preceding the keyword “ [symbol] .” For example, if the preset number is 3, the second media data is “Burj Al Arab” and the second recognition module performs recognition on the second media data.

Further, obtaining the final recognition result of the media data at least based on the first recognition result and the second recognition result may include: determining a preset location with respect to the keyword in the first recognition result, and placing the second recognition result in the preset location with respect to the keyword in the first recognition result, thereby obtaining the final recognition result of the media data.

Further, because the second media data is obtained from a location in the first media data that corresponds to the preset location with respect to the keyword, by placing the second recognition result recognized by the second media data into the preset location that corresponds to the location where the second media data is extracted, namely, the preset location with respect to the keyword in the first recognition result, the combination of the first recognition result and the second recognition result is realized.

For example, the first recognition result may be “ [symbol] XXX [symbol] ” (meaning “help me book a room at hotel XXX”), which includes the keyword “ [symbol] ” (meaning “hotel”). The terms at a preset location with respect to the keyword is “XXX,” and the terms (i.e., “Burj Al Arab”) in a location of the first media data that corresponds to the preset location may be treated as the second media data. The second media data may be recognized to obtain the second recognition result “ [symbol] ” (meaning “Burj Al Arab”), and the second recognition result “ [symbol] ” is placed at the location of “XXX” in the first recognition result to replace “XXX.” Accordingly, the final recognition result is obtained.

In some embodiments, the first media data may be the same as or different from the media data. For example, terms other than “XXX” in the sentence “ [symbol] XXX [symbol] ” may be used as the first media data, and the location of “XXX” may be replaced with the same number of spaces. If the first media data is different from the media data, the media data needs to be checked to determine the terms in the media data recognizable by the first recognition module. The terms recognizable by the first recognition module may be used as the first media data.

In the disclosed electronic apparatus, the processor is configured to obtain media data, and output first media data to the first recognition module to obtain the first recognition result of the first media data, where the first media data is at least a part of the media data. The processor is further configured to output second media data to the second recognition module to obtain the second recognition result of the second media data, where the second media data is at least a part of the media data. The processor is further configured to obtain a final recognition result of the media data at least based on the first recognition result and the second recognition result. In the present disclosure, by recognizing the media data respectively through the first recognition module and the second recognition module, the recognition of multiple languages is realized, which enhances the user experience.

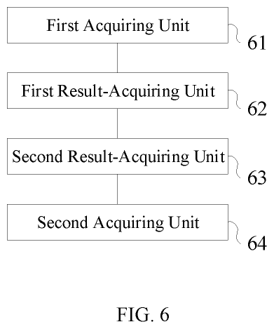

FIG. 6 illustrates a structural schematic view of a processing device according to some embodiments of the present disclosure. As shown in FIG. 6, the processing device may include a first acquiring unit 61, a first result-acquiring unit 62, a second result-acquiring unit 63, and a second acquiring unit 64.

The first acquiring unit 61 may be configured for obtaining media data. The first result-acquiring unit 62 may be configured for outputting first media data to a first recognition module, and obtaining a first recognition result of the first media data, where the first media data is at least a part of the media data. The second result-acquiring unit 63 may be configured for outputting second media data to a second recognition module, and obtaining a second recognition result of the second media data, where the second media data is at least a part of the media data. The second acquiring unit 64 is configured for obtaining a final recognition result of the media data at least based on the first recognition result and the second recognition result.

The disclosed processing device may adopt the aforementioned processing method.

In the disclosed processing device, the processor is configured to obtain media data, and output first media data to the first recognition module to obtain the first recognition result of the first media data, where the first media data is at least a part of the media data. The processor is further configured to output second media data to the second recognition module to obtain the second recognition result of the second media data, where the second media data is at least a part of the media data. The processor is further configured to obtain a final recognition result of the media data at least based on the first recognition result and the second recognition result. In the present disclosure, by recognizing the media data respectively through the first recognition module and the second recognition module, the recognition of multiple languages is realized, which enhances the user experience.

The embodiments in this specification are described in a progressive manner. Each embodiment focuses differently from the other embodiments. For the same and similar parts between the embodiments, reference can be made to each other. For the device disclosed in the embodiment, since it corresponds to the method disclosed in the embodiment, the description is relatively simple. For the relevant part, refer to the description of the method section.

Those skilled in the art may further realize that units and algorithm steps of the examples described in connection with the embodiments disclosed can be implemented by electronic hardware, computer software, or a combination of the two. To clearly illustrate the interchangeability of hardware and software, in the above description, composition and steps of each example have been described generally in terms of functions. Whether these functions are performed by hardware or software depends on specific application and design constraints of the technical solution. Those skilled in the art can use different methods to implement the described functions for each specific application, but this implementation should not be considered beyond the scope of the present disclosure.

The steps of the method or algorithm described in connection with the embodiments disclosed herein may be directly implemented by hardware, a software module executed by the processor, or the combination of the two. The software module can be placed in random access memory (RAM), memory, read-only memory (ROM), electrically programmable ROM, electrically erasable programmable ROM, registers, a hard drive, removable disks, CD-ROM, or any other form of storage medium known in technical fields.

With the above description of the disclosed embodiments, those skilled in the art can implement or use the present application. Various modifications to these embodiments will be apparent to those skilled in the art, and the general principles defined herein may be implemented in other embodiments without departing from the spirit or scope of the application. Therefore, this application will not be limited to the embodiments shown herein, but should conform to the widest scope consistent with the principles and novel features disclosed herein.

What is claimed is:

1. A data processing method, comprising:
obtaining media data;
outputting first media data to a first recognition module, and obtaining a first recognition result of the first media data, wherein the first media data is a part of the media data;
outputting second media data to a second recognition module, and obtaining a second recognition result of the second media data, wherein the second media data is a part of the media data; and
obtaining a final recognition result of the media data based on the first recognition result and the second recognition result.

2. The method according to claim 1, wherein the outputting second media data to a second recognition module comprises:
determining whether the first recognition result satisfies a preset condition;
in response to the first recognition result satisfying the preset condition, determining second media data; and
outputting the second media data to the second recognition module.

3. The method according to claim 2, wherein the preset condition comprises:
identifying a keyword in the first recognition result; or
identifying data in the first recognition unit that is unrecognized by the first recognition module.

4. The method according to claim 3, wherein:
the preset condition is identifying the keyword in the first recognition result; and
the outputting the second media data to the second recognition module includes:
determining the keyword in the first recognition result from a plurality of candidate keywords;
determining a second recognition module to which the keyword corresponds from a plurality of candidate recognition modules; and
outputting the second media data to the second recognition module.

5. The method according to claim 3, wherein:
in response to the preset condition being identifying the keyword in the first recognition result, the determining the second media data includes: determining data at a preset location with respect to the keyword in the first media data as the second media data; and
in response to the preset condition being identifying the data in the first recognition unit that is unrecognized by the first recognition module, the determining the second media data includes: determining the data unrecognized by the first recognition module as the second media data.

6. The method according to claim 5, wherein:
in response to the preset condition being identifying the keyword in the first recognition result, the obtaining the final recognition result of the media data based on the first recognition result and the second recognition result includes: determining a preset location with respect to the keyword in the first recognition result, and placing the second recognition result in the preset location with respect to the keyword in the first recognition result, thereby obtaining the final recognition result of the media data; and
in response to the preset condition being identifying the data in the first recognition unit that is unrecognized by the first recognition module, the obtaining the final recognition result of the media data based on the first recognition result and the second recognition result includes: determining a location of data unrecognizable by the first recognition module in the first recognition result, and placing the second recognition result in the location of the data unrecognizable by the first recognition module in the first recognition result, thereby obtaining the final recognition result of the media data.

7. The method according to claim 1, wherein:
the media data, the first media data, and the second media data are same.

8. The method according to claim 7, wherein the obtaining the final recognition result of the media data based on the first recognition result and the second recognition result includes:
obtaining the first recognition result by using the first recognition module to recognize a first portion of the media data, obtaining the second recognition result by using the second recognition module to recognize a second portion of the media data, and combining the first recognition result and the second recognition result to obtain the final recognition result of the media data; or
obtaining the first recognition result by using the first recognition module to recognize the media data, obtaining the second recognition result by using the second recognition module to recognize the media data, matching the first recognition result and the second recognition result to obtain a multi-language matching degree order, and determining the final recognition result of the media data based on the multi-language matching degree order.

9. An electronic apparatus, comprising:
a processor,
the processor being configured for:
obtaining media data;
outputting first media data to a first recognition module, and obtaining a first recognition result of the first media data, wherein the first media data is a part of the media data;
outputting second media data to a second recognition module, and obtaining a second recognition result of the second media data, wherein the second media data is at least a part of the media data; and
obtaining a final recognition result of the media data based on the first recognition result and the second recognition result; and
a memory, configured to store the first recognition result, the second recognition result, and the final recognition result.

10. The electronic apparatus according to claim 9, wherein:
the processor is further configured for:
determining whether the first recognition result satisfies a preset condition;
in response to the first recognition result satisfying the preset condition, determining second media data; and
outputting the second media data to the second recognition module.

11. The electronic apparatus according to claim 10, wherein the preset condition comprises:
identifying a keyword in the first recognition result; or
identifying data in the first recognition unit that is unrecognized by the first recognition module.

12. The electronic apparatus according to claim 11, wherein:
the preset condition is identifying the keyword in the first recognition result; and
the processor is further configured for:
determining the keyword in the first recognition result from a plurality of candidate keywords;
determining a second recognition module to which the keyword corresponds from a plurality of candidate recognition modules; and
outputting the second media data to the second recognition module.

13. The electronic apparatus according to claim 11, wherein:
in response to the preset condition being identifying the keyword in the first recognition result, the processor is further configured for: determining data at a preset location with respect to the keyword in the first media data as the second media data; and
in response to the preset condition being identifying data in the first recognition unit that is unrecognized by the first recognition module, the processor is further configured for: determining the data unrecognized by the first recognition module as the second media data.

14. The electronic apparatus to claim 13, wherein:
in response to the preset condition being identifying the keyword in the first recognition result, the processor is further configured for: determining a preset location with respect to the keyword in the first recognition result, and placing the second recognition result in the preset location with respect to the keyword in the first recognition result, thereby obtaining the final recognition result of the media data; and
in response to the preset condition being identifying data in the first recognition unit that is unrecognized by the first recognition module, the processor is further configured for: determining a location of data unrecognizable by the first recognition module in the first recognition result, and placing the second recognition result in the location of the data unrecognizable by the first recognition module in the first recognition result, thereby obtaining the final recognition result of the media data.

15. A computer readable medium containing program instructions for causing a computer to perform the method of:
receiving media data;
outputting first media data to a first recognition module, and obtaining a first recognition result of the first media data, wherein the first media data is a part of the media data;
outputting second media data to a second recognition module, and obtaining a second recognition result of the second media data, wherein the second media data is at least a part of the media data; and
obtaining a final recognition result of the media data based on the first recognition result and the second recognition result.

16. The computer readable medium according to claim 15, wherein:
the processor is further configured for:
determining whether the first recognition result satisfies a preset condition;
in response to the first recognition result satisfying the preset condition, determining second media data; and
outputting the second media data to the second recognition module.

17. The computer readable medium according to claim 16, wherein the preset condition comprises:
identifying a keyword in the first recognition result; or
identifying data in the first recognition unit that is unrecognized by the first recognition module.

18. The computer readable medium according to claim 17, wherein:
the preset condition is identifying keyword in the first recognition result; and
the processor is further configured for:
determining the keyword in the first recognition result from a plurality of candidate keywords,
determining a second recognition module to which the keyword corresponds from a plurality of candidate recognition modules, and
outputting the second media data to the second recognition module.

19. The computer readable medium according to claim 17, wherein:
in response to the preset condition being identifying the keyword in the first recognition result, the processor is further configured for: determining data at a preset location with respect to the keyword in the first media data as the second media data; and
in response to the preset condition being identifying data in the first recognition unit that is unrecognized by the first recognition module, the processor is further configured for: determining the data unrecognized by the first recognition module as the second media data.

20. The computer readable medium according to claim 19, wherein:
in response to the preset condition being identifying the keyword in the first recognition result, the processor is further configured for: determining a preset location with respect to the keyword in the first recognition result, and placing the second recognition result in the preset location with respect to the keyword in the first recognition result, thereby obtaining the final recognition result of the media data; and
in response to the preset condition being identifying data in the first recognition unit that is unrecognized by the first recognition module, the processor is further configured for: determining a location of data unrecognizable by the first recognition module in the first recognition result, and placing the second recognition result in the location of the data unrecognizable by the first recognition module in the first recognition result, thereby obtaining the final recognition result of the media data.
